(19) United States
(12) Patent Application Publication
(10) Pub. No.: US 2024/0380704 A1
(43) Pub. Date: Nov. 14, 2024

(54) DEVICE AND METHOD FOR MANAGING PERFORMANCE DECREASES IN HYBRID WIRED/WIRELESS TSN NETWORKS

(71) Applicant: COMMISSARIAT A L’ENERGIE ATOMIQUE ET AUX ENERGIES ALTERNATIVES, PARIS (FR)

(72) Inventors: Siwar BEN HADJ SAID, GIF-SUR-YVETTE (FR); Minh-Thuyen THI, GIF-SUR-YVETTE (FR); Michael BOC, GIF-SUR-YVETTE (FR)

(21) Appl. No.: 18/692,297

(22) PCT Filed: Nov. 3, 2022
(86) PCT No.: PCT/EP2022/080617

§ 371 Date: Mar. 14, 2024

(30) Foreign Application Priority Data
Nov. 9, 2021 (FR) 2111854

(51) Int. Cl. H04L 47/28; H04J 3/06; H04L 47/24

(52) U.S. Cl. CPC H04L 47/28; H04J 3/0638; H04L 47/24

(57) ABSTRACT

A method for attenuating performance degradation of an IEEE 802.1 hybrid wired/wireless time sensitive network (TSN) in terms of time synchronization and quality of service (QOS) scheduling. The method makes it possible to attenuate the impact of clock drift on AS and the impact of clock jump on Qbv scheduling. The method comprises two mechanisms that consist (i) in grouping together the nodes of the network into subdomains and assigning a redundant grandmaster per subdomain; and (ii) in coordinating the TSN switches of a subdomain before applying corrected Qbv scheduling.

### CROSS-REFERENCE TO RELATED APPLICATIONS

This application is a National Stage of International patent application PCT/EP2022/080617, filed on Nov. 3, 2022, which claims priority to foreign French patent application No. FR 2111854, filed on Nov. 9, 2021, the disclosures of which are incorporated by reference in their entireties.

### FIELD OF THE INVENTION

The present invention is in the field of time-sensitive networks (TSN), and more particularly of such TSN networks having wired links and wireless links. The invention proposes methods and devices for handling performance degradations in wired/wireless TSN networks, also referred to as hybrid wired/wireless TSN networks or, more succinctly, hybrid TSN networks in the present description. The invention addresses in particular degradations in time synchronization and quality of service scheduling (QOS scheduling).

### BACKGROUND

TSN is a set of standards, defined by the IEEE 802.1 Working Group, that extend the Ethernet network in order to meet the stringent requirements of real-time communications.

Data transmission for real-time critical applications (for example fast regulation, signal acquisition in electrical networks or movement control) and data-intensive applications (for example video streams or computer systems) is implemented at present in separate networks in order to avoid mutual interference. However, the increasing flexibility and digitization of working processes has led to the need for increasing fusion of computerization and industrial operation, and thus fusion of systems that were previously separate. By extending and adapting the existing Ethernet standards, TSN creates a convergence between information technology (IT) and industrial operational technology (OT) in industrial networks. This means that real-time critical data and data-intensive applications are able to be implemented over a common Ethernet cable without interfering with one another.

The TSN specifications (IEEE 802.1) provide deterministic services, enabling real-time transmission of data within a foreseeable framework within a known time span in industrial environments, such as machine control applications in production processes, from sensor to cloud. TSN offers guaranteed latency and quality of service with time synchronization.

The various documents of the TSN standard offer a complete real-time communication solution when used together in collaboration. The specifications generally fall into four categories:
Time synchronization, corresponding to the IEEE 802.1AS standard, in which all equipments participating in real-time communication must have a common understanding of time;
Low latency, corresponding for example to the IEEE 802.1Qbv standard, in order to ensure a quality of service QoS;
High reliability, corresponding for example to the IEEE 802.1CB standard;
Network configuration, corresponding for example to the IEEE 802.1Qcc standard.

With regard to time synchronization, unlike the standard Ethernet from the IEEE 802.3 standard, time plays an important role in TSN networks. For real-time communication, with anomalies and time limits that are non-negotiable for end-to-end transmission latencies, all peripherals of this network must have a common time reference and must synchronize their clocks with one another. This is true not only for the end equipments of a communication stream, such as an industrial controller and a manufacturing robot, but also for the components of the network, such as Ethernet switches. It is only by way of synchronized clocks that it is possible to make all of the devices of the network work in unison and make them carry out the required operations exactly at the desired time.

Time synchronization in TSN networks may be achieved with various technologies. In theory, it is possible to implement all of the network equipments and switches with a radio clock or GPS clock. This would be expensive, and there is no guarantee that the signal will always be accessible to all. For these reasons, the time in TSN networks is generally distributed from a central time source directly via the network itself.

Moreover, TSN was initially designed for the Ethernet network. However, there are nowadays increasing demands for a wireless TSN network and a hybrid wired/wireless TSN network.

FIG. 1a illustrates a simplified example of a hybrid wired/wireless TSN network 100, comprising two equipments (102, 110) that are able to communicate data through a succession of switches (“bridge or switch” 104, 106, 108) that are connected either to the equipments, or to one another, by wired links (103, 107, 109) or non-wired links (105). In the example of FIG. 1a, the equipment 102 is connected, by a wire 103, to a switch 104 that is connected, by a wireless link 105, to a switch 106 that is connected, by a wired link 107, to a switch 108 that is connected, by a wired link 109, to an equipment 110. Those skilled in the art will understand that the representation of the hybrid TSN network of FIG. 1a is simplified to the extreme so as to clearly explain the problem of performance degradation. This representation is non-limiting, and a hybrid wired/wireless TSN network may comprise a plurality of TSN nodes made up of equipments, switches, and wired and wireless links. The TSN nodes within the meaning of the present invention may encompass any type of device or machine or apparatus able to transmit and receive data via the communication protocols implemented for the TSN network.

In the network of FIG. 1a, a node 102 having the role of master in line with the TSN principles advertises its clock as being the reference clock for the network, and sends advertisement messages to the other nodes of the network (104, 106, 108, 110), who have a slave role.

Generally speaking, any node of the network may be designated as master. The node that plays the role of master is commonly referred to as grandmaster (GM), and the other nodes that play the role of slave are each referred to as slave. The roles may be assigned by a human or by an algorithm, such as for example the “Best Master Clock Algorithm” (BMCA).

The IEEE 802.1AS standard, which will be referred to as AS in the remainder of the description, allows TSN devices (that is to say of the TSN network) to synchronize their clocks with the reference clock of a GM. The known “Precision Time Protocol” (PTP) protocol and its enhanced version, the “Generalized Precision Time Protocol” (gPTP) protocol, are used to synchronize the clocks. This protocol is established in line with the principle of master clock and slave clocks. The master clock serving as a time reference is called a “reference clock”, and its time may possibly be synchronized (via GPS, NTP, etc.) to a clock called a global clock.

The TSN devices continuously exchange PTP or gPTP messages. During operation, the master distributes the time signal to its slaves, respectively, in order to determine the delay. To this end, a timestamp in the form of a synchronization message “PTP SYNC” is sent, at T1, from the master reference clock to the slave, which determines the time of receipt, T2, of the timestamps based on its own time. The slave also transmits a delay request message “Delay REQ”, at T3, to the master, whose time of receipt, T4, by the master is then returned to the slave as a delay response message “Delay RESP”. The master-slave delay ‘T4−T3’ and the slave-master delay ‘T2−T1’ that are determined as the differences between the timestamps make it possible to compute an average delay ‘[(T4−T3)+(T2−T1)]/2’, from which the slave knows the difference between its clock and the master clock, and that allows it to set its clock.

With regard to quality of service, the IEEE 802.1Qbv standard, referred to as Qbv in the remainder of the description, contributes to guaranteed latency services in TSN. The Qbv standard allows the TSN switches to carry out scheduling based on quality of service QoS, in order for example to guarantee the quality of priority traffic.

FIG. 1b illustrates, on the architecture 100 of the TSN network of FIG. 1a, one example with two network streams (112, 114) between two equipments (102, 110), which may be programmed in transmission by switches (104, 106, 108) that periodically open their ports to transmit data for the two streams. Moreover, if one stream has a higher priority, for example the first stream 112, it is then served longer than the second, lower-priority stream 114.

The AS and Qbv standards are important for future industrial communication systems, in particular in smart factories equipped with autonomous manufacturing systems. In these systems, devices such as robots, actuators and sensors have to communicate rapidly with one another since they have to react very quickly depending on the command and control system, or depending on certain unexpected events. These systems are thereby able to guarantee the precision of a manufacturing process and minimize any defects.

In TSN for Ethernet, wired links offer high reliability in terms of delay and jitter. When these wired links coexist with wireless links, TSN services may then be degraded due to unexpected delay and jitter of the wireless links.

The GM may then become inaccessible if the PTP or gPTP messages, that is to say the synchronization and advertisement messages, are not received by the slaves for a certain time.

Two main reasons for the inaccessibility of a GM are (i) malfunctioning of the GM and (ii) lack of reliability of wireless links. This inaccessibility of the GM then impacts the AS and Qbv standards.

The impact on AS is such that, when the GM is inaccessible, the clocks of the slave equipments may drift from the reference clock of the GM. This clock drift then causes imprecision in the time synchronization.

The impact on Qbv is such that, when the GM is accessible and reachable again, the clocks of the slave equipments are again synchronized with the reference clock of the GM, but the resynchronization may potentially cause a significant jump or shift in the clocks of the slaves. This clock drift and this clock jump or shift may lead to imprecision or asynchronous scheduling in Qbv.

There are known approaches for addressing these problems.

In the IEEE 802.1AS 2019 and 802.1AS 2020 standards, the authors presented the idea of GM deduplication, in order to have a main GM and a hot-standby GM. The TSN network is split into two subdomains (reference is made to PTP or gPTP domain and subdomain), the subdomains being defined so as to overlap, and each of them covers the entire network. The limits of this approach are that it does not take into account the way in which the hot-standby GM is selected, nor the way in which Qbv degradation is managed.

Some publications discuss only the problem of clock drift and of improving PTP performance in industrial wireless local area networks, but without considering Qbv.

Other articles propose solutions for improving the precision of AS by estimating delays and clock drift of a hybrid wired/wireless network. They introduce a path deviation delay filter in order to exclude aberrant delay values caused by congestion or loss.

Patent application WO2020067977A1 deals with the interoperation between a cellular communication network and a TSN network, and aims to attenuate time synchronization degradation. The authors focused on how to pass PTP messages via the wireless cellular network. To compute residence time on the cellular domain, the approach is based on “translators” that are placed at the ingress and egress nodes of the domain and that take the timestamp of the PTP messages. However, Qbv is not taken into account in this approach.

Patents U.S. Pat. Nos. 9,577,817 and 9,692,614 propose the use of a redundant GM to improve time synchronization performance of a network embedded in a vehicle. However, these solutions concern only embedded wired networks and do not discuss the issues of “how to select the redundant GM?”, “how to assign subdomains?”, and, “how to manage Qbv degradation?”.

More precisely, in abovementioned patent U.S. Pat. No. 9,692,614, the authors proposed for a switch to be able to change from a normal operating mode with the primary GM to an operating mode with a secondary or redundant GM if the network detects that the primary GM is lost. By way of example, a node closest to the primary GM may serve as secondary GM. When the main GM restarts, the slaves synchronize with the secondary GM and the procedure of selecting a new GM is not necessary. This solution considers only embedded wired networks, which are generally smaller and less complicated than industrial hybrid wired/wireless networks. This approach, just like that in the AS standard, does not consider the scenario where a wireless link separates a group of nodes from all GMs. Finally, no details are given about the way in which the secondary GM is selected so as to attenuate jitter or clock jump, and there is no mention of taking into account Qbv performance degradation or Qbv scheduling recovery.

Therefore, there is no solution for hybrid wired/wireless TSN networks that makes it possible to handle performance degradations, in particular to jointly handle time synchronization and quality of service scheduling degradations. The present invention addresses these various needs.

### SUMMARY OF THE INVENTION

One object of the present invention is to propose a method and a device for implementation thereof, making it possible to manage performance degradation in hybrid wired/wireless time-sensitive networks (TSN), and more precisely to attenuate the performance degradation of AS and Qbv caused by clock drift and clock jump.

Another object of the present invention is a method that aims to eliminate the factor of frequency drift of the oscillator both on the device having the role of GM and on slave equipments.

In general, the principle of the invention is based on what is referred to as a domain-based and subdomain-based approach to handle performance degradation problems both for AS and for Qbv.

The invention proposes a new definition of a subdomain that makes it possible to adapt to a new hybrid wired/wireless TSN network topology. The subdomains of the present invention, rather than overlapping as in the AS standard, are separated from one another. Wireless links will make it possible to establish virtual separations over an entire TSN network, in order to create multiple distinct subdomains, each subdomain grouping together a plurality of nodes, of a number fewer than the nodes of the domain, and where all of the nodes of one and the same subdomain are connected in wired form.

Advantageously, the method of the present invention operates in a modular manner, each module being a functional group corresponding to an independent sequence of steps. The method of the invention thus comprises a sub-method for reorganizing the general network by dividing it into a plurality of subdomains, with a primary subdomain and a plurality of secondary subdomains, and for determining how to assign a respective subdomain to a set of equipments; a sub-method for determining how to select a secondary master or secondary GM in each subdomain, a sub-method for determining how to compute a defer time, and a sub-method for determining how to recover a corrected Qbv schedule.

Advantageously, depending on the characteristics and requirements of the real system for which the method is implemented, each of the sub-methods may be modified and adapted independently of the other sub-methods.

The present invention may be implemented in industrial systems, such as a network of automation control systems. It may also be implemented in all other networks using the TSN protocol, such as networks of future smart transport systems. The present invention is thus particularly suitable for a hybrid wired/wireless TSN network, even when this is a relatively large-scale network made up of a large number of devices.

However, even though manufacturing systems are important applications, the present invention is not limited to these systems, and may be applied to any system where TSN is used. One example is thus autonomous driving systems where TSN is necessary to transmit critical traffic to infrastructures either inside a vehicle, from vehicle to vehicle, or from a vehicle to road infrastructures. In these systems, the link between the vehicle and the infrastructures, which is generally wireless, is vulnerable. The present invention may advantageously be used to deal with this vulnerability.

The invention may be implemented directly on hardware and/or software. It may take the form of a product for providers of industrial systems solutions sold to customers, such as factory owners. These solutions may be purely hardware, purely software, or both. Software solutions may be provided via software and firmware updates.

The invention may also be of direct interest to factory owners, who may implement it themselves and use it in their factory. It may also be applicable for network equipment providers, notably 5G/6G equipment providers.

The advantageous features of the present invention are mainly as follows:
it does not rely on complex algorithms;
it is widely applicable in the field of smart manufacturing and Industry 4.0, which is a rapidly growing market;
it addresses the most significant problems of the AS and Qbv standards, namely clock drift and clock jump. These two standards are also included in some of the most important TSN standards;
it addresses the problem of the inaccessible GM, which is highly possible in hybrid wired-wireless networks. This problem is particularly significant in critical industrial systems, because it may affect the schedule and the quality of manufacturing processes;
it relies on the concept of “hot-standby GM”, present in the AS standard, thus avoiding the introduction and implementation of new concepts in the standard;
it is based on independent subdomains that have their own secondary GM to synchronize with.

In order to obtain the desired results, what is proposed is a method for managing performance degradation of a time-sensitive network TSN as claimed in the independent method claim.

The invention may be implemented according to alternative or combined embodiments, as claimed in the dependent method claims.

The invention also relates to a device for managing performance degradation of a time-sensitive network TSN comprising a plurality of nodes, a node being an equipment transmitting and/or receiving data streams or a switch transmitting data streams, the nodes being connected by wired links or wireless links, the TSN network having a node acting as master GM in line with the TSN principles in order to advertise its clock as the reference clock to the slave nodes of the network, the device comprising means for implementing the steps of the method of the invention.

The invention addresses the use of the claimed device in a centralized time-sensitive network, the architecture of the centralized network being an architecture implemented in line with what is known as the “software-defined networking” model.

The invention also relates to a computer program product comprising code instructions for carrying out the steps of the method of the invention when the program is executed on a computer.

### BRIEF DESCRIPTION OF THE DRAWINGS

Other features and advantages of the invention will become apparent from the following description and the figures of the appended drawings, in which:

FIG. 1a illustrates a simplified example of a hybrid wired/wireless TSN network;

FIG. 1b illustrates, on the TSN network architecture of FIG. 1a, an example of two streams between two equipments;

FIG. 2 illustrates another simplified example of a hybrid wired/wireless TSN network for implementing the invention in an industrial context, according to one embodiment;

FIG. 3a illustrates subdomains on the exemplary network architecture of FIG. 1a, according to one embodiment of the invention;

FIG. 3b illustrates a failed wireless link between the subdomains of FIG. 3a, according to one embodiment of the invention;

FIG. 4 is a flowchart for illustrating the various functionalities carried out by various equipments of a hybrid wired/wireless TSN network, in one embodiment of the invention;

FIG. 5a is a timing diagram of cyclic scheduling for transmitting streams via wired and wireless switches of a hybrid TSN network;

FIG. 5b illustrates the re-establishment of a lost wireless link, and the drift of the clocks of wired and wireless switches for the timing diagram of FIG. 5a;

FIG. 5c illustrates an adjustment of the clocks of the wired and wireless switches;

FIG. 6 is a timing diagram of various steps of the method of the invention, in one exemplary embodiment.

### DETAILED DESCRIPTION

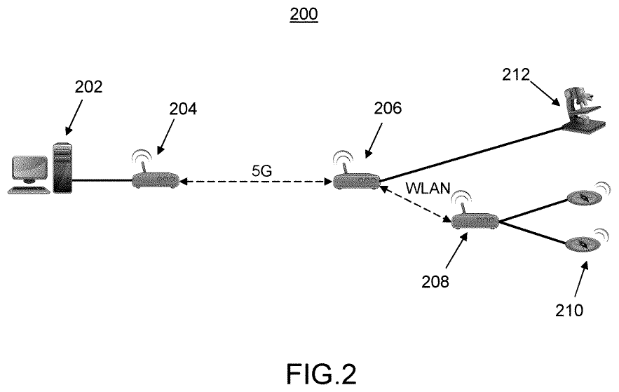

One context for implementing the invention in an industrial environment is illustrated in FIG. 2, which shows a simplified TSN network topology to allow a clear description of the principles of the present invention. Those skilled in the art will be able to apply these principles in general to any other environment, regardless of the field of application and regardless of the complexity of the network topology.

FIG. 2 comprises a controller 202 of an automation system 200 configured to communicate with end equipments (210, 212) over wired and wireless paths via various switches (204, 206, 208). In the context of Industry 4.0, the end equipments may be robots 212 and sensors 210.

Generally, the controller 202 of the automation system is located on a remote site separated from the field devices (206, 208, 210, 212) by a wireless link, for example a 5G link. Among the field devices, robots (212) and actuators are generally separated from sensors (210) by wireless links of a local area network, for example a WLAN network.

In this environment, implementing the TSN standards allows the network equipments to synchronize their clocks and transfer network traffic deterministically, that is to say with a limited range of drift and latency. For example, the devices must have a common clock time in order for the robots 212 to synchronize their movements and carry out very precise actions. The common clock time also enables the robots to quickly receive the signals from the controller 202 and the sensors 210, in order to react in real time to operational events and thus avoid manufacturing defects.

In one embodiment, the controller 202 is designated as being the device that has the role of grandmaster and that holds the reference clock to which all of the slave clocks of the TSN network synchronize.

The method of the invention, which makes it possible to attenuate the impact of clock drift on AS and the impact of clock jump on Qbv scheduling, comprises two mechanisms.

The first mechanism consists in creating subdomains of the general domain of the network, where each subdomain groups together multiple nodes of the network, and in assigning, for each subdomain apart from the one that contains the grandmaster, a hot-standby grandmaster or redundant grandmaster.

The second mechanism of the invention consists in coordinating the TSN switches before applying corrected Qbv schedules, if there is potentially a significant clock jump.

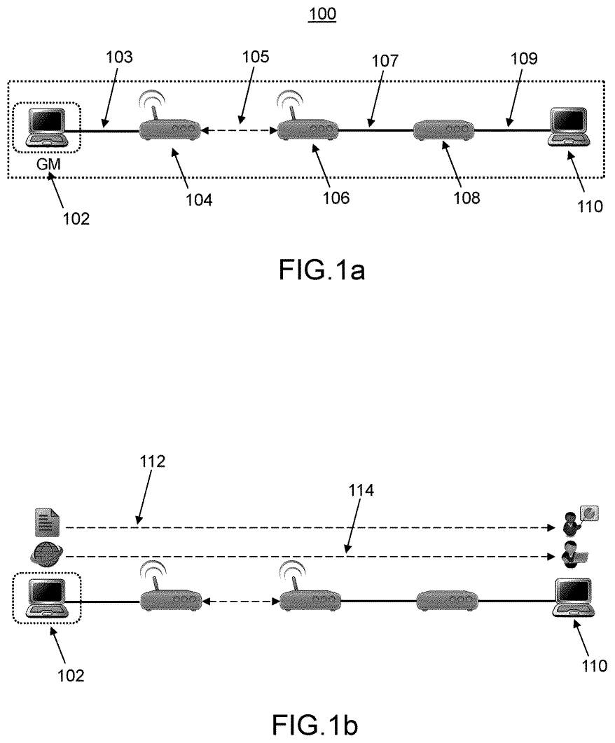

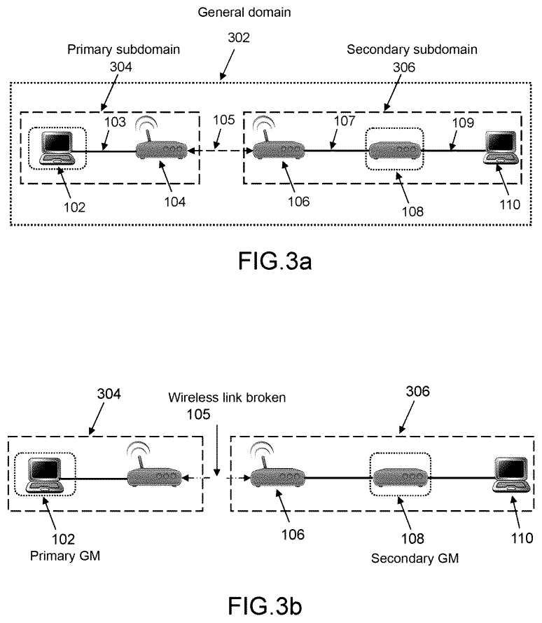

FIGS. 3a and 3b make it possible to illustrate the first mechanism of creating subdomains with a hot-standby grandmaster for the simplified TSN network topology of FIG. 1a. The references for identical elements remain the same.

In order to attenuate the impact of clock drift on AS, the general domain 302 of the TSN network (gPTP or PTP domain, but only gPTP is mentioned to simplify the description) is divided into multiple gPTP subdomains (304, 306), and a hot-standby GM 108 is assigned to each subdomain, except for the one that contains the primary GM 102.

In one embodiment, the subdomains are assigned such that two subdomains are separated only by wireless links. Thus, in FIG. 3a, the subdomain 304 is separated from the subdomain 306 by the wireless link 105.

In other embodiments, depending on the context, other rules for assigning subdomains may be defined. Another rule may for example be defined such that each subdomain must have at least one node with a high-precision clock, for example, the clock of the global positioning system (GPS).

Each subdomain thus has an ingress node, which is the node connected wirelessly to another subdomain. In the example of FIG. 3a, the node 106 is the ingress node of the subdomain 306.

After the subdomains have been created, the first mechanism consists in assigning a role of redundant GM to a node for each subdomain.

In one embodiment, assigning the role of redundant GM to a node consists in determining and selecting, from among all of the nodes of one and the same subdomain, the node whose clock frequency best corresponds to that of the primary GM, that is to say to which it is closest.

In another embodiment, assigning the role of redundant GM to a node consists in determining and selecting, from among all of the nodes of one and the same subdomain, the node whose clock is the most precise.

Those skilled in the art will be able to establish other node selection criteria to define the redundant GMs of the subdomains.

The topology of a TSN network, after the first subdomain creation mechanism has been applied, thus contains three types of nodes, which are: the main GM node, redundant GM nodes, and slave nodes.

In the example of FIG. 3a, the node 108 is designated redundant GM for the subdomain 306 grouping together the nodes (106, 108, 110), the node 102 being the initial GM of the global TSN network and becoming the GM of its subdomain 304 grouping together the nodes (102, 104).

When a node is designated as main GM, it is configured for and assigned only to the role of master. When a node is assigned to be a slave, it is configured for and assigned only to the role of slave. When a node is assigned to be a redundant GM, it is configured to sometimes act as slave and to sometimes act as both slave and master for its subdomain.

Thus, in the example of FIG. 3a, the node 102 is configured to act only as master (that is to say GM of the subdomain 304); the nodes (104, 106, 110) are configured to act only as slaves; the node 108 is configured either to act only as slave when the wireless link between the subdomains (304, 306) is active, or to act as slave and master of its subdomain 306 when the wireless link between the subdomains (304, 306) is broken.

When the selection of all of the GMs is complete for a plurality of subdomains ‘n’, the network has a main GM, designated primary GM, which is assigned to the entire network and to a primary subdomain, and it has as many hot-standby GMs, designated secondary GMs, as there are secondary subdomains ‘n−1’.

During normal operational operation of the network, a secondary GM synchronizes its clock with the primary GM, like any other slave node of the network.

In one advantageous embodiment, IEEE 802.1AS time synchronization via PTP may be evaluated using simple software, that is to say the difference between the clock frequency of each node and the clock frequency of the primary GM is measured by AS software, in the form of a clock frequency correction.

When the primary GM is inaccessible, for example if the wireless link 105 between the primary subdomain 304 and a secondary subdomain 306 has failed as illustrated in FIG. 3b, the clocks of the slave nodes that have a clock frequency different from that of the primary GM will start drifting. Advantageously, according to the method of the invention, when the primary GM 102 is inaccessible and the slaves of one or more other subdomains are no longer able to synchronize precisely to this GM, all of the slaves (106, 110) belonging to one and the same subdomain will synchronize to the secondary GM 108 assigned to their subdomain.

Thus, in the example of FIG. 3b, the slave nodes (106, 110) will synchronize to the secondary GM 108 of the subdomain 306 to which they belong. Given that the secondary GM was selected because it is the node of this subdomain that has a clock frequency closest to that of the primary GM, the difference between the clock of the primary GM and the clocks of the slaves decreases, and performance degradation of AS is reduced as a result.

Advantageously, the method of the invention operates distributively and independently between the subdomains. In one practical embodiment, clock drift is detected in each subdomain by the secondary GM. The detection of clock drift is then independent between the subdomains, this meaning that clock drift may be detected in one subdomain but not detected in another subdomain.

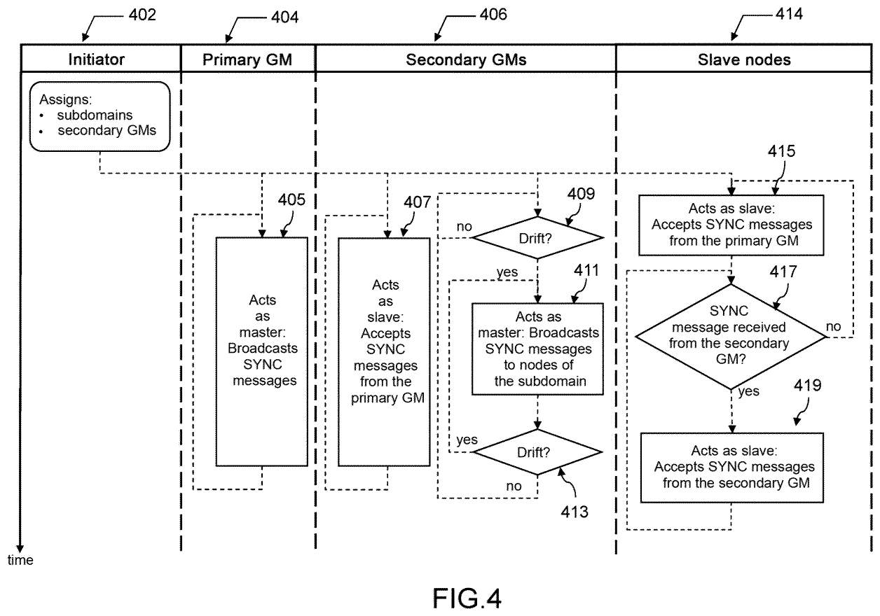

FIG. 4 illustrates, in a flowchart, the various functionalities carried out by the various equipments of a hybrid wired/wireless TSN network, in one embodiment of the invention.

An “initiator” entity 402 is configured to create a plurality of subdomains in a TSN network, and then select and assign the role of secondary GM 406 to a node in each subdomain.

In one embodiment, the initiator may be the same entity as the one that designates the initial GM of the global TSN network. The initiator may be either a person, a distributed algorithm, or a centralized algorithm running on a centralized controller such as a software-defined networking (SDN) controller.

For those skilled in the art, what is referred to as an SDN approach corresponds to a network architecture model that allows network administrators to manage network services by abstracting functionalities, to control or configure the network intelligently and in a centralized manner using software applications. This consists of a set of technologies having the following in common:
centralized control of network resources;
centralized orchestration;
virtualization of physical resources.

A TSN network is made up of a plurality of equipments that are sources and/or recipients of data streams in the TSN network. A centralized network configuration system comprises an SDN controller coupled to a functional entity that comprises SDN service software applications and that may comprise notably a software application for carrying out steps of the method of the invention.

This functional entity, implemented in the form of an SDN service (that is to say virtualized network service), interfaces with the SDN controller via a “northbound” interface of the controller. The SDN controller interfaces with the TSN network via its “southbound” interface, notably to TSN switches and optionally directly to TSN end nodes. In one embodiment, the SDN service is implemented within the CNC/CUC (centralized network configuration/centralized user configuration) as a computer program comprising code instructions for carrying out steps of the method of the invention in the operational phase of the network.

Returning to FIG. 4, after the roles have been assigned to the nodes of the TSN network, the initial GM of the global network becomes the primary GM 404 for all subdomains and acts only as master, by broadcasting 405 SYNC messages to the slave nodes of the network, in a manner that is common and known.

Once it has been assigned to the role of secondary GM 406, a secondary GM node acts only as slave, and receives and accepts 407 the SYNC messages from the primary GM, in a known manner, in order to synchronize with the primary GM at any time.

Each secondary GM will then enter a check loop, in order to regularly check 409 whether clock drift with the clock of the primary GM is observed. The method makes it possible to determine whether the clock frequency correction value that is continuously computed, for example by the AS software, corresponds to clock drift. As long as the value is below a threshold, the check continues (branch “no” of 409).

In one embodiment, the value of the threshold is chosen based on the synchronization precision requirement of the actual system application (for example a factory robot system). The value of the threshold is configurable, and may initially be chosen by the person configuring the TSN network, or chosen by an algorithm.

If the computed value is greater than a threshold, clock drift occurs. When clock drift is detected (branch “yes” of 409), the sub-method in the secondary GM keeps the node as slave of the primary GM, and additionally activates 411 a local GM function in order to allow the secondary GM to act as local GM at the same time for all of the nodes belonging to its subdomain. The secondary GM that is activated broadcasts 413 SYNC synchronization messages to all of the nodes of its subdomain, and regularly checks 413 whether clock drift is detected by determining whether the clock frequency correction value that is computed continuously corresponds to clock drift.

As long as drift is present (branch “yes” of 413), the secondary GM continues to act as local master for all of the nodes of its subdomain. If no drift is detected any more (branch “no” of 413), the method makes it possible to deactivate the local master function and keeps only the slave function of the primary GM active.

With regard to the slave nodes 414 in a subdomain, each node acts 415 as slave of the primary GM, by receiving 415 the SYNC synchronization messages from the primary GM, in a known manner, in order to synchronize with the primary GM at any time.

Each slave node will then regularly check 417 whether it receives a SYNC synchronization message from the secondary GM of the subdomain to which it belongs.

When a slave node receives a local SYNC synchronization message, that is to say from the secondary GM of the subdomain to which it belongs, which then acts as local master, it continues to act as slave by receiving and accepting 419 the local SYNC messages for as long as they are sent by the secondary GM.

When the primary GM becomes accessible again, the slaves immediately resynchronize with the primary GM. At this point, the secondary GM stops acting as local master for its subdomain, while continuing to synchronize with the primary GM.

However, there is a risk of these slaves making a significant clock jump due to excessively great drift. When a jump forward or backward takes place, the schedule of the Qbv scheduler is shifted forward or backward, respectively. As a result, the precision of the Qbv scheduling is affected. In order to attenuate the impact of clock jump on the Qbv scheduling, the method of the present invention implements steps that make it possible to coordinate the TSN switches with one another, before applying the corrected Qbv schedules.

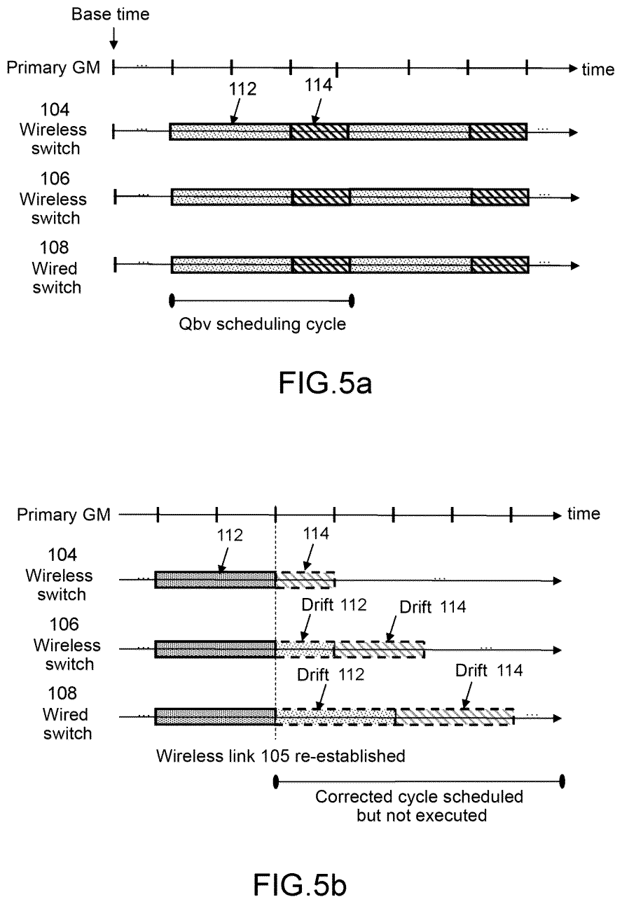

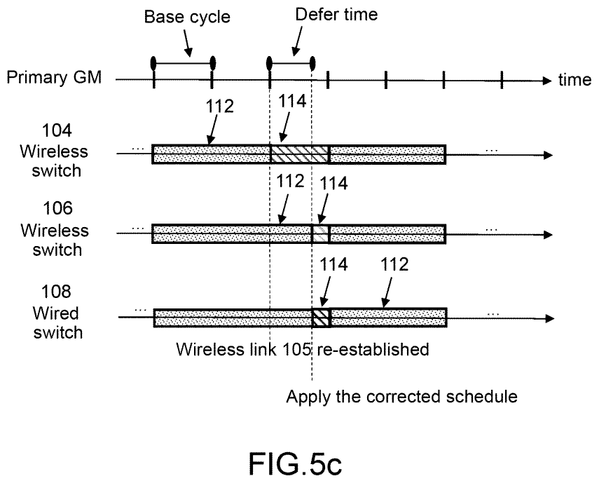

FIGS. 5a to 5c illustrate the restoration method according to the invention for the example of FIGS. 3a and 3b, where:
FIG. 5a is a timing diagram of a Qbv scheduling cycle for transmitting two streams (112, 114) via wired and wireless switches (108 and 104, 106) of a hybrid TSN network according to FIG. 3a. In the example, the stream 112 has a higher priority than the stream 114, this being represented by a longer duration in the cycle;
FIG. 5b illustrates the drift of the clocks of the wireless and wired switches 106 and 108 resulting from the loss of the wireless link 105 between the primary subdomain 304 and the subdomain 306, and then the re-establishment of the wireless link, where a corrected scheduling cycle is computed but not yet executed; and
FIG. 5c illustrates an adjustment of the clocks of the wireless and wired switches 106 and 108 with the application of the corrected Qbv scheduling cycle.

In more detail, at the start of the Qbv process, all of the nodes of the TSN network define a common base time (FIG. 5a), thereby allowing them to ascertain when and what Qbv scheduling to carry out over time.

Following the loss of a wireless link 105 between the primary subdomain 304 and a secondary subdomain 306, the main GM becomes inaccessible, and the clock frequency of the switches (104, 106) of the isolated subdomain drifts from one another, the switches no longer being able to synchronize to the clock of the main GM. Depending on the distance from a switch of the isolated subdomain to the main GM, the clock drift may be greater. In the example illustrated in FIG. 5b, the wired switch 108 has clock drift greater than the wireless switch 106.

Once the main GM is able to be reached again (wireless link 105 re-established in FIG. 5b), the switches of the isolated subdomain may each synchronize their clock frequency and their clock time with the main GM again (principle of accepting SYNC messages sent by the main GM), but they do not yet apply the new corrected Qbv cycle, that is to say the cycle is scheduled but it is not yet executed.

In one embodiment of the method of the invention, a defer time is determined by each TSN switch of one and the same secondary subdomain, as illustrated in FIG. 5c. During this defer time, the switches are in standby mode before applying a new corrected Qbv cycle. For the duration of the defer time, however, each switch continues to execute its scheduled Qbv schedule.

When the defer time has been counted down, all of the switches individually apply the new corrected Qbv scheduling cycle for their subdomain.

In one embodiment, the defer time is computed using PTP message exchanges.

The standard messages to which reference is made, in particular the “Sync”, “Pdelay_Req” and “Pdelay_Resp” messages, are defined and described in detail in the IEEE 802.1AS-2020 standard-“IEEE Standard for Local and Metropolitan Area Networks—Timing and Synchronization for Time-Sensitive Applications”, IEEE P802.1ASRev, January 2020, to which those skilled in the art may refer.

A preliminary step makes it possible to define an identifier “Domain_ID” for each subdomain and an initial accumulated delay value “Accumulated_Delay” between the ingress node of the subdomain in question and the node furthest therefrom in this subdomain.

The domain identifier makes it possible to identify, in a PTP message, the subdomain concerned by the message, which may pass through multiple subdomains. The nodes (that is to say equipments) of a subdomain work only with PTP messages that belong to their subdomain.

In one embodiment, the furthest node is the node that requires the highest number of hops to be reached. Each subdomain updates and maintains its identifier Domain_ID and the accumulated delay value Accumulated_Delay.

According to some embodiments, the identifier Domain_ID and the initial accumulated delay value Accumulated_Delay are defined either by a person configuring the TSN network, by a distributed algorithm, or by a centralized algorithm running on a centralized controller such as a software-defined networking (SDN) controller.

In one embodiment, the method makes it possible to use the Suffix field in the header of the PTP or gPTP messages, in particular the Suffix field of the Sync messages and the Pdelay_Req messages, to declare the domain identifier Domain_ID, the initial value of the accumulated delay Accumulated_Delay and then its update (current value of the accumulated delay).

The method of the invention allows each node of a secondary subdomain to update the value of the accumulated delay Accumulated_Delay. In one embodiment, the value Accumulated_Delay is updated by adding a value ‘Pdelay’ to the current value of Accumulated_Delay inherited from its neighbor upon receipt of a Pdelay_Resp message.

In this way, at any time, the ingress node of a subdomain, for example the wireless switch 106 of the subdomain 306 of FIG. 3a, knows (by way of the value of the Accumulated_Delay field in the last received Pdelay_Req message) the accumulated delay to its furthest-away node, that is to say the node 110 of FIGS. 3a and 3b.

Another phase of the invention occurs when it is determined that the main GM becomes accessible again after a wireless link with a subdomain has been broken. The ingress node of each subdomain will then use another Suffix field, designated as the ‘flag’ field, to advertise to all of the switches of its subdomain that they must defer the application of a new corrected Qbv cycle by a certain time—the defer time.

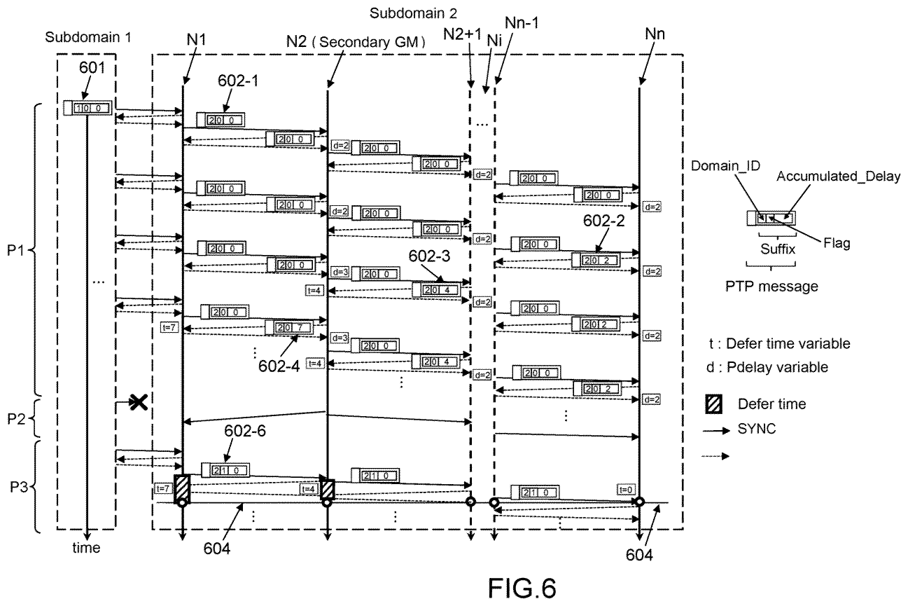

The indication that a defer time has been activated may for example result in a change in the value of a bit in the flag field (0 or 1). The value of the defer time, identified by a variable ‘t’ in FIG. 6, corresponds, for each node, to the value of the accumulated delay Accumulated_Delay for this node.

FIG. 6 illustrates, for multiple nodes (N1, N2, . . . . Ni, . . . , Nn) of a subdomain having the identifier “Subdomain2”, the evolution of the various fields of the Suffix implemented during the propagation of a PTP message 602. As illustrated, one field, the one on the left, is reserved for filling in the domain identifier, here indicated at 2 for reasons of simplicity; one field, the one on the right, is reserved for filling in and updating the value of the accumulated delay “Accumulated_Delay” for each node; and one field, that is to say the central field named ‘flag’, is reserved for indicating the time to trigger the application of a new corrected Qbv schedule.

The example of FIG. 6 illustrates the exchanges of a plurality of PTP messages between the various nodes N1 to Nn, for a first phase P1 where the primary GM belonging to a primary subdomain “Subdomain1” is accessible; then, for a second phase P2 where the primary GM is inaccessible, the wireless link between the primary subdomain and the secondary subdomain being broken, and the PTP messages of the primary subdomain no longer reach the secondary subdomain; then, for a third phase P3 where the primary GM becomes accessible again, and PTP messages are again able to be received by the secondary subdomain.

In the first phase P1, a message 601 from the primary subdomain arrives at the ingress node N1 of the subdomain 2. The node updates the identifier of its domain in the corresponding field, the Suffix fields then indicating “2/0/0”, respectively, and the message 602-1 is propagated from the ingress node N1 to the next neighboring node N2, which, in the example. has been assigned to the role of secondary GM. The node N2 relays the message 602-1 to its neighboring node N3, and so on until the last node Nn of the subdomain 2, which is the node furthest (in terms of number of hops) from the ingress node N1.

Using the delay request message and delay response message Pdelay_Req and Pdelay_Resp, each node computes, in a conventional PTP manner, a value ‘d’ for the delay offset Pdelay. In the example, the node N2 computes a value of d=2, which means that the delay offset Pdelay is equal to 2 microseconds (for this unit of time).

According to the method of the invention, each node updates the value of the accumulated delay in the Accumulated_Delay field when it receives a Pdelay_Req message from a neighbor.

In one embodiment, when the “Accumulated_Delay” field contains a value signifying that the accumulated delay is zero (value equal to 0 or empty field for example), the nodes consider that this field is empty and ignore it; and if the “Accumulated_Delay” field is not empty or contains a value signifying that there is an accumulated delay, the nodes take into account the value contained in this field.

Using the Pdelay_Req messages, the value of the accumulated delay is propagated from the furthest node to the ingress node in backpropagation mode.

In the example, the Accumulated_Delay field was updated by the furthest node Nn when sending a Pdelay_Req message (602-2), by adding the value of d=2.

In turn, the node N2+1 updates the accumulated delay value by adding the value of its delay offset (d=2) to the value of the accumulated delay existing in the

Accumulated_Delay field of the Pdelay_Req message received from the neighboring node. The value of the accumulated delay in the example is equal to 4. The node N2+1 propagates, with a Pdelay_Req message (602-3), the value of the accumulated delay to its neighbor N2. After multiple rounds of this propagation, each node knows the accumulated delay of itself to the node furthest from the ingress node.

Each node stores, in a local memory, the value of the accumulated delay received by its neighbor, as a variable ‘t’ that makes it possible to compute the defer time before the application of the corrected Qbv schedule. In the example, for the secondary GM node N2, the defer time has a value t=4, indicating that its defer time is 4 microseconds.

In the example of FIG. 6, the node N2 stores the value t=4 corresponding to the value written to the Accumulated_Delay field of the message 602-3 received from its neighbor N2+1.

When the node N2 sends a next Pdelay_Req message (602-4) to its neighbor N1, the node N2 updates the Accumulated_Delay field by adding the value of its delay offset (here set to d=3) to the value of the accumulated delay existing in the Accumulated_Delay field (equal to 4 here). The value of the accumulated delay is then equal to 7 in the example.

This accumulated delay value is stored by the ingress node N1 as a variable ‘t’ to define the defer time.

Once the main GM, which was inaccessible during a phase P2 when the secondary GM N2 activated its role of GM for the nodes of its subdomain, becomes accessible again in phase P3, the ingress node N1 of the secondary subdomain, upon receipt of a new SYNC message, modifies the value of the ‘Flag’ field (for example from 0 to 1), before sending the new message 602-6 to its neighboring node N2. Propagating the SYNC message informs the other nodes to prepare to apply a new corrected Qbv schedule.

Upon receipt of the SYNC message, each node starts up a counter to count down a defer time, equal to the last value of the variable ‘t’ that it stored, before applying the corrected Qbv schedule.

The corrected schedule is applied 604 at the same time for all of the nodes of the re-established subdomain.

Thus, when the main GM becomes accessible again, all of the switches, upon receipt of the new PTP or gPTP message sent by this GM, know that they will have to execute the corrected Qbv schedule for a priority network stream in line with the principles of TSN scheduling. However, given that some switches are not scheduled correctly due to clock drift, they coordinate with one another using the defer time so as to agree to execute the scheduling of the priority network stream after a certain number of clock cycles. The switches also update the base time. In this way, the inaccuracy of the Qbv schedule is limited only to past Qbv schedules, and not to future Qbv schedules.

In another embodiment, the defer time may consist in predefining a value large enough for this value to be, most of the time, greater than the accumulated transmission delay of a packet between any two nodes within one and the same subdomain. A corrected Qbv schedule is applied for all of the nodes of the re-established subdomain, after the predefined defer time value has been counted down.

FIG. 5c illustrates one example where wired and wireless switches apply a new corrected Qbv schedule, after 6 clock cycles, a value that has been predefined as a defer time value, for a base cycle of 10 clock cycles.

Advantageously, the process of defining or computing the defer time is carried out locally within each subdomain. On the whole TSN network, this is carried out propagatively, subdomain by subdomain. In other words, each subdomain computes and maintains its defer time distributively, locally in its subdomain. In this way, the defer time may differ from one subdomain to another.

The process of computing the defer time is carried out in a distributed manner for at least two reasons.

First of all, in general, the clocks of one and the same subdomain are synchronized more precisely than the clocks between various subdomains.

Second of all, it is generally more important to remain synchronized with nodes inside one and the same subdomain than with nodes outside the subdomain. This is due to the fact that there are potentially local area network streams that have a listener and a talker that coexist in the same subdomain. In addition, there may be transmissions that may have been terminated by other subdomains, and the rest of the data to be transmitted (back-off) may be carried out locally within a subdomain.

A description has been given of a method for attenuating Qbv degradation due to inaccessibility of the main GM. However, the method may be applied to other scenarios, such as, for example, it may be implemented for a TSN network that has a link that is frequently congested.

1. A method for managing performance degradation of a time-sensitive network TSN comprising a plurality of nodes, a node being an equipment transmitting and/or receiving data streams or a switch transmitting data streams, the nodes being connected by wired links or wireless links, the TSN network having a node acting as master GM in line with the TSN principles in order to advertise its clock as the reference clock to the slave nodes of the network, the method being computer-implemented and comprising the following steps:
dividing the TSN network into a primary subdomain and a plurality of secondary subdomains, each subdomain grouping together a set of different nodes connected only by wired links, the primary subdomain grouping together at least the master node GM, each secondary subdomain having an ingress node connected wirelessly to another subdomain;
selecting, in each secondary subdomain, a node to act as master with respect to the other slave nodes of said subdomain, said selected node being configured to operate as a slave node of the master node GM during normal operating mode of the TSN network with a predefined Qbv schedule for said TSN network in line with the IEEE 802.1 Qbv standard that enables the TSN switches to carry out scheduling based on quality of service QoS, and said node being configured to operate as a secondary master node in line with the TSN principles in order to advertise its clock as the reference clock to the slave nodes of its subdomain, when the wireless link with the primary subdomain is broken;
computing a defer time for each node of one and the same secondary subdomain, the defer time corresponding to a waiting time for each node before applying a corrected Qbv schedule after a lost wireless link is re-established for this subdomain; and
after the re-establishment of a wireless link for a secondary subdomain, each node of said secondary subdomain counting down said determined defer time and applying a corrected Qbv schedule, the secondary master node of said secondary subdomain again operating as slave node of the master node GM.

2. The method as claimed in claim 1, wherein the step of dividing the TSN network consists in creating subdomains such that two subdomains are separated only by wireless links.

3. The method as claimed in claim 1, wherein the step of dividing the TSN network consists in creating subdomains such that each subdomain has at least one node with a high-precision clock, for example the clock of the global positioning system (GPS).

4. The method as claimed in claim 1, wherein the step of selecting, in each secondary subdomain, a node to act as master consists in determining, from among all of the nodes of one and the same subdomain, the node whose clock frequency best corresponds to that of the primary GM, notably the node whose clock frequency is closest to that of the GM.

5. The method as claimed in claim 3, wherein the step of selecting, in each secondary subdomain, a node to act as master consists in selecting said node having a high-precision clock.

6. The method as claimed in claim 1, wherein the step of computing a defer time for each node of one and the same secondary subdomain comprises the following steps:
defining an identifier “Domain_ID” for said secondary subdomain and an initial accumulated delay value “Accumulated_Delay” between the ingress node of said secondary subdomain and the node furthest therefrom;
each node computing a delay offset value (Pdelay);
each node updating the initial accumulated delay value, by adding the delay offset value to an accumulated delay value received from a neighbor of said node.

7. The method as claimed in claim 6, furthermore comprising a step consisting, for each node, in storing the updated accumulated delay value, said last stored value corresponding, for said node, to the value of the defer time after the re-establishment of a wireless link for said secondary subdomain.

8. The method as claimed in claim 1, comprising, before the step of counting down a defer time, a step consisting in determining when a wireless link between the primary subdomain and a secondary subdomain is broken, and a step consisting in determining when said wireless link is re-established.

9. The method as claimed in claim 8, wherein the step of determining when a wireless link between the primary subdomain and a secondary subdomain is broken consists in determining whether or not there is clock drift between the reference clock of the master node GM and the clocks of the slave nodes of said secondary subdomain, and the step of determining when said wireless link is re-established consists in determining whether or not there is clock drift between the reference clock of the secondary master node and the clocks of the slave nodes of said secondary subdomain.

10. The method as claimed in claim 1, wherein the step of computing a defer time is carried out using the Suffix fields of “Sync”, “Pdelay_Req” and “Pdelay_Resp” messages defined by the IEEE 802.1AS standard.

11. A computer program product, said computer program comprising code instructions for carrying out the steps of the method as claimed in claim 1 when said program is executed on a computer.

12. A device for managing performance degradation of a time-sensitive network TSN comprising a plurality of nodes, a node being an equipment transmitting and/or receiving data streams or a switch transmitting data streams, the nodes being connected by wired links or wireless links, the TSN network having a node acting as master GM in line with the TSN principles in order to advertise its clock as the reference clock to the slave nodes of the network, the device comprising means for implementing the steps of the method as claimed in claim 1.

13. The use of the device as claimed in claim 12 in a centralized time-sensitive network, the architecture of the centralized network being an architecture implemented in line with what is known as the “software-defined networking” model.
